(19) United States
(12) Patent Application Publication
(10) Pub. No.: US 2025/0013844 A1
(43) Pub. Date: Jan. 9, 2025

(54) IMAGE FORMING CONTROL METHOD, IMAGE FORMING APPARATUS, AND IMAGE FORMING SYSTEM

(71) Applicant: KYOCERA Document Solutions Inc., Osaka (JP)

(72) Inventor: Naoki Sekioka, Osaka (JP)

(21) Appl. No.: 18/750,906

(22) Filed: Jun. 21, 2024

(30) Foreign Application Priority Data
Jul. 3, 2023 (JP) 2023-109156

(51) Int. Cl. G06K 15/02; B41J 2/21

(52) U.S. Cl. CPC G06K 15/027; B41J 2/2135

(57) ABSTRACT

A processor transmits, when a test print event occurs, test PDL data which is data expressing a test image and information on a print condition by a page description language to an image processing apparatus via a communication device. The processor receives job data including raster data expressing the test image and the information on the print condition from the image processing apparatus via the communication device in correspondence with the transmitting of the test PDL data. The processor causes a printing device to execute processing of forming the test image that is based on the raster data on a sheet according to the print condition in correspondence with the receiving of the job data.

### INCORPORATION BY REFERENCE

This application is based upon and claims the benefit of priority from the corresponding Japanese Patent Application No. 2023-109156 filed on Jul. 3, 2023, the entire contents of which are incorporated herein by reference.

### BACKGROUND

The present disclosure relates to an image forming control method for controlling processing of forming a test image used for adjusting print parameters on a sheet, an image forming apparatus, and an image forming system.

An image forming apparatus may have a function of forming various test images on a sheet for adjusting print parameters. A user adjusts the print parameters according to conditions of the test images formed on the sheet.

For example, it is known that the image forming apparatus forms color patches on a sheet for checking development colors. The color patch is an example of the test image.

### SUMMARY

An image forming control method according to an aspect of the present disclosure is a method of controlling an image forming apparatus including a printing device which forms an image on a sheet and a communication device. The image forming control method includes transmitting, by a processor, when a test print event occurs, test PDL data which is data expressing a test image and information on a print condition by a page description language, to an image processing apparatus via the communication device. The image forming control method further includes receiving, by the processor, job data including raster data expressing the test image and the information on the print condition from the image processing apparatus via the communication device in correspondence with the transmitting of the test PDL data. The image forming control method further includes causing, by the processor, the printing device to execute processing of forming the test image that is based on the raster data on the sheet according to the print condition in correspondence with the receiving of the job data.

An image forming apparatus according to another aspect of the present disclosure includes the printing device, the communication device, and the processor which realizes the image forming control method.

An image forming system according to another aspect of the present disclosure includes the image forming apparatus and an image processing apparatus communicable with the image forming apparatus. The image processing apparatus includes an image processing portion which receives the test PDL data from the image forming apparatus, converts the test PDL data into the job data, and transmits the job data to the image forming apparatus.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming system according to an embodiment;

FIG. 2 is a block diagram showing a configuration of a control device of an image forming apparatus in the image forming system according to the embodiment;

FIG. 3 is a block diagram showing a configuration of an image processing apparatus;

FIG. 4 is a flowchart showing exemplary procedures of test print control in the image forming system according to the embodiment;

FIG. 5 is a diagram showing an example of registration data and test PDL data in the image forming system according to the embodiment; and

FIG. 6 is a diagram showing an example of a configuration of token definition data in the image forming system according to the embodiment.

### DETAILED DESCRIPTION

Hereinafter, an embodiment of the present disclosure will be described with reference to the drawings. It is noted that the following embodiment is an example of embodying the present disclosure and does not limit the technical scope of the present disclosure.

### [Image Forming System 100]

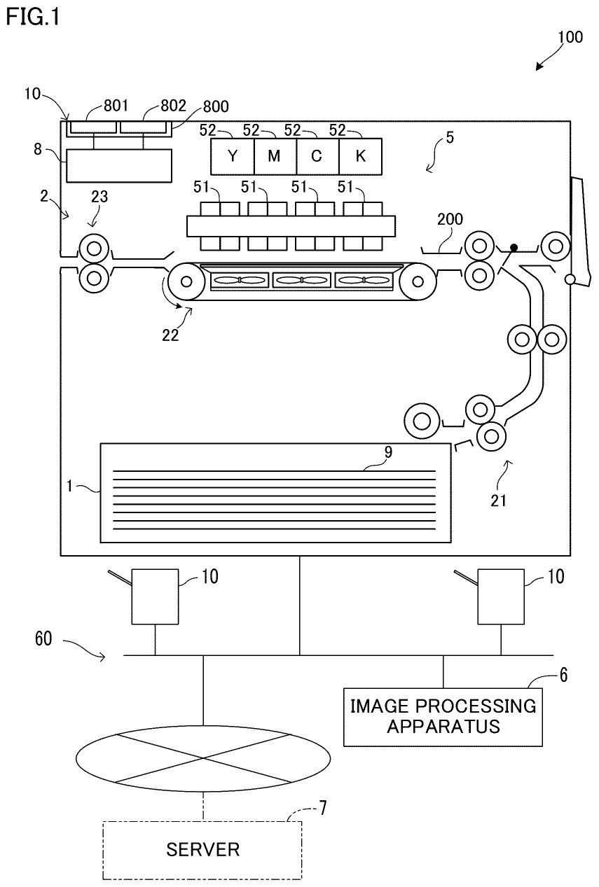

An image forming system 100 according to the embodiment includes one or more image forming apparatuses 10 and an image processing apparatus 6 communicable with the image forming apparatuses 10 (see FIG. 1).

The image forming apparatus 10 includes a sheet storing portion 1, a sheet conveying device 2, an a printing device 5 (see FIG. 1).

The image forming apparatus 10 further includes a human interface device 800 and a control device 8. The control device 8 controls the sheet conveying device 2 and the printing device 5.

The sheet conveying device 2 feeds sheets 9 stored in the sheet storing portion 1 one by one to a conveying path 200. Further, the sheet conveying device 2 conveys the sheets 9 along the conveying path 200.

In the present embodiment, the sheet conveying device 2 includes a primary conveying device 21, a belt conveying device 22, and a secondary conveying device 23.

The primary conveying device 21 feeds the sheet 9 from the sheet storing portion 1 to the conveying path 200. Further, the primary conveying device 21 conveys the sheet 9 along the conveying path 200 and feeds the sheet 9 to the belt conveying device 22.

The belt conveying device 22 takes over the conveyance of the sheet 9 from the primary conveying device 21. The belt conveying device 22 conveys the sheet 9 along the conveying path 200 and further feeds the sheet 9 to the secondary conveying device 23.

The secondary conveying device 23 takes over the conveyance of the sheet 9 from the belt conveying device 22. The secondary conveying device 23 conveys the sheet 9 along the conveying path 200 and further feeds the sheet 9 from the conveying path 200 to a subsequent-stage portion (not shown). The subsequent-stage portion is, for example, a discharge tray, a post-processing device, a relay conveying device, or the like.

The printing device 5 executes print processing. The print processing is processing of forming an image on the sheet 9 conveyed along the conveying path 200.

In the present embodiment, the printing device 5 forms an image on the sheet 9 conveyed by the belt conveying device 22. In the example shown in FIG. 1, the printing device 5 executes the print processing using an inkjet system.

In the example shown in FIG. 1, the printing device 5 includes a plurality of inkjet units 51 and a plurality of ink supply portions 52 respectively corresponding to a plurality of colors.

The plurality of ink supply portions 52 respectively supply ink of different colors to the plurality of inkjet units 51. The plurality of inkjet units 51 discharge ink onto the sheet 9 to thus form an image on the sheet 9.

It is noted that the printing device 5 may alternatively be a device which executes the print processing using a system other than the inkjet system, such as electrophotography, for example.

### [Human Interface Device 800]

The human interface device 800 includes an operation device 801 and a display device 802.

The operation device 801 is a device which detects operations of people. For example, the operation device 801 includes one or both of a touch panel and operation buttons.

The display device 802 is a device which displays various types of information. For example, the display device 802 is a panel display device such as a liquid crystal display panel.

### [Control Device 8]

The control device 8 includes a CPU (Central Processing Unit) 81, a RAM (Random Access Memory) 82, a secondary storage device 83, a signal interface 84, a communication device 85, and the like.

The secondary storage device 83 is a nonvolatile computer-readable storage device. The secondary storage device 83 is capable of storing and updating computer programs and various types of data. For example, one or both of a flash memory and a hard disk drive is/are adopted as the secondary storage device 83.

The signal interface 84 converts signals output from various sensors into digital data and transmits the digital data obtained by the conversion to the CPU 81. Further, the signal interface 84 converts control commands output from the CPU 81 into control signals and transmits the control signals to a device to be controlled.

The communication device 85 executes communication with other apparatuses such as the image processing apparatus 6 and a server 7 on a cloud via a network 60. The CPU 81 communicates with the other apparatuses via the communication device 85. The network 60 includes a LAN (Local Area Network), the Internet, and the like.

The CPU 81 is a processor which executes the computer programs to execute various types of data processing and control. The control device 8 including the CPU 81 controls the sheet conveying device 2, the printing device 5, and the like.

The RAM 82 is a volatile computer-readable storage device. The RAM 82 primarily stores the computer programs to be executed by the CPU 81 and data to be output and referenced by the CPU 81 during a process executing various types of processing.

The CPU 81 includes a plurality of processing modules that are realized by executing the computer programs. The plurality of processing modules of the CPU 81 include a main control portion 8a, a print control portion 8b, and the like.

The main control portion 8a executes processing of starting various types of processing according to occurrence of various processing events, and the like. The processing events include an operation event, a reception event, and the like.

The operation event is an event that operations of various processing requests have been detected by the operation device 801. The reception event is an event that commands of the various processing requests have been received via the communication device 85. The processing requests include a print request that requests execution of the print processing.

The print control portion 8b controls the sheet conveying device 2 and the printing device 5. The print control portion 8b controls the sheet conveying device 2 to thus control conveyance of the sheets 9.

In addition, the print control portion 8b causes the printing device 5 to execute the print processing in sync with the conveyance of the sheets 9 by the sheet conveying device 2.

For example, when the print request is received by the communication device 85, the print control portion 8b causes, as well as cause the sheet conveying device 2 to convey the sheet 9, the printing device 5 to execute the print processing.

### [Image Processing Apparatus 6]

The image processing apparatus 6 is an information processing apparatus such as a personal computer. The image processing apparatus 6 includes a CPU 61, a RAM 62, a secondary storage device 63, a human interface device 64, a communication device 65, and the like (see FIG. 3).

The secondary storage device 63 is a nonvolatile computer-readable storage device. The secondary storage device 63 is capable of storing and updating computer programs and various types of data. For example, one or both of a flash memory and a hard disk drive is/are adopted as the secondary storage device 63.

The RAM 62 is a volatile computer-readable storage device. The RAM 62 primarily stores the computer programs to be executed by the CPU 61 and data to be output and referenced by the CPU 61 during a process executing various types of processing.

The human interface device 64 includes an operation portion 64a and a display portion 64b (see FIG. 3). The operation portion 64a is a device which detects operations of people, such as a keyboard and a mouse. The display portion 64b is a device which displays various types of information. For example, the display portion 64b is a panel display device such as a liquid crystal display panel.

The communication device 65 executes communication with external apparatuses such as the image forming apparatus 10 via the network 60. The CPU 61 communicates with the external apparatuses via the communication device 65.

The CPU 61 includes a plurality of processing modules that are realized by executing the computer programs. The plurality of processing modules of the CPU 61 include a main processing portion 6a, an image processing portion 6b, and the like (see FIG. 3).

The main processing portion 6a receives and transmits data from/to the image forming apparatus 10 via the communication device 65. In addition, the main processing portion 6a controls the human interface device 64.

The image processing portion 6b executes various types of image processing that are based on data received from the image forming apparatus 10.

The image forming apparatus 10 has a test print function for forming various test images on the sheet 9 for adjusting print parameters. The user of the image forming apparatus 10 adjusts the print parameters according to a condition of the test image formed on the sheet 9.

Incidentally, the image forming apparatus 10 downloads various programs or data from the server 7 on a cloud via the network 60 to thus upgrade various functions. A content of the test image, a print condition used when forming the test image, and the like are also a target of the upgrade.

Meanwhile, the image forming apparatus 10 executes the print processing for the test image based on raster data expressing the test image. A data size of the raster data is large, and a computation load of processing of generating the raster data is large.

Accordingly, when the image forming apparatus 10 possesses raster data expressing the test image, a computation load of the image forming apparatus 10 for forming the test image is large. In addition, a communication load of the image forming apparatus 10 for upgrading data related to the test image is large.

In the image forming system 100, the image forming apparatus 10 and the image processing apparatus 6 execute test print control to be described later. Thus, a load of the image forming apparatus 10 when forming the test image and updating the data related to the test image is reduced.

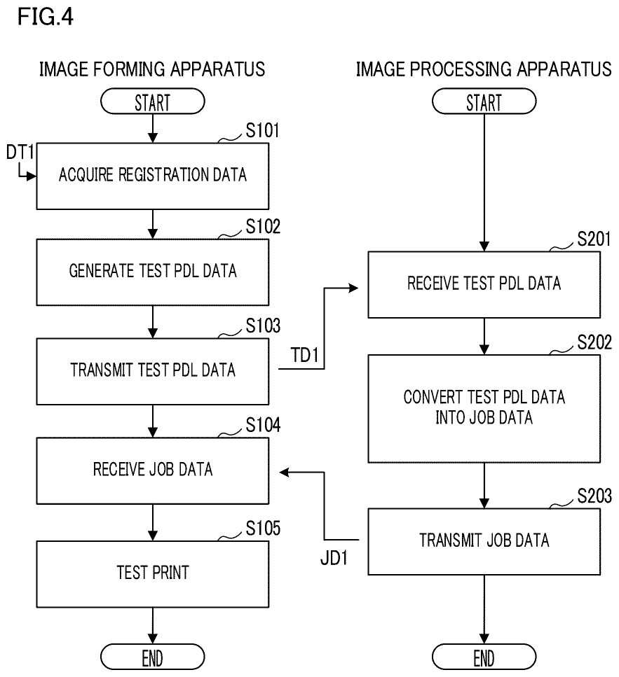

Hereinafter, exemplary procedures of the test print control will be described with reference to the flowchart shown in FIG. 4.

In descriptions below, S101, S102, . . . represent identification codes of a plurality of steps in processing executed by the CPU 81 of the image forming apparatus 10 in the test print control. S201, S202, . . . represent identification codes of a plurality of steps in processing executed by the CPU 61 of the image processing apparatus 6 in the test print control.

When a test print event occurs, the main control portion 8a of the CPU 81 starts the test print control. For example, the test print event is an event that automatically occurs every time the print processing is executed for a preset reference number of sheets 9.

Alternatively, the test print event may be an event that a test print request has been input via the operation device 801 or the communication device 85.

### <Step S101>

In the test print control, processing of Step S101 is executed first. In Step S101, the main control portion 8a acquires registration data DT1 stored in advance in the secondary storage device 83.

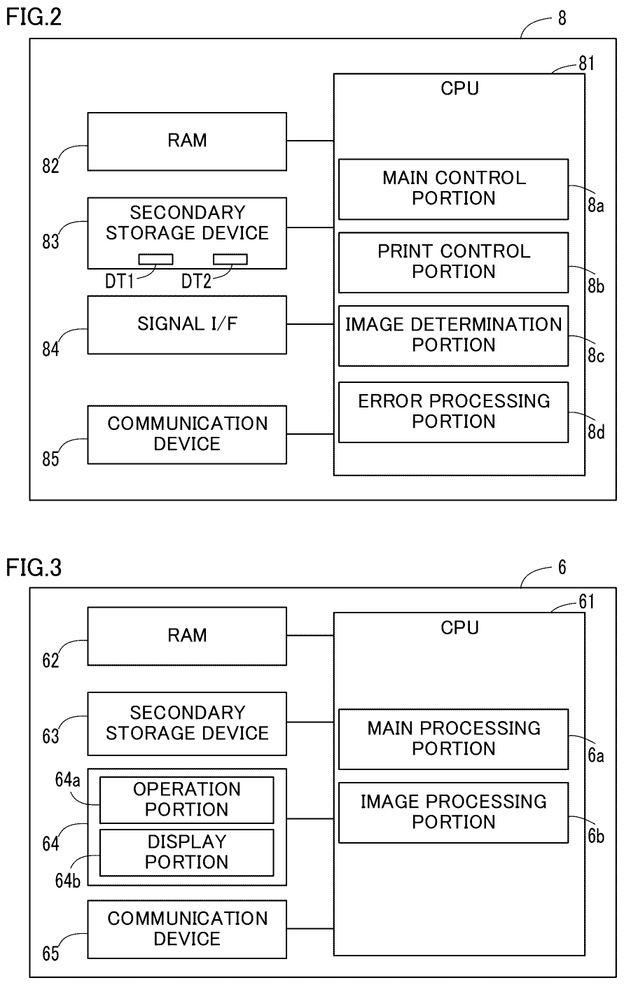

As shown in FIG. 2, the registration data DT1 and token conversion data DT2 are stored in advance in the secondary storage device 83.

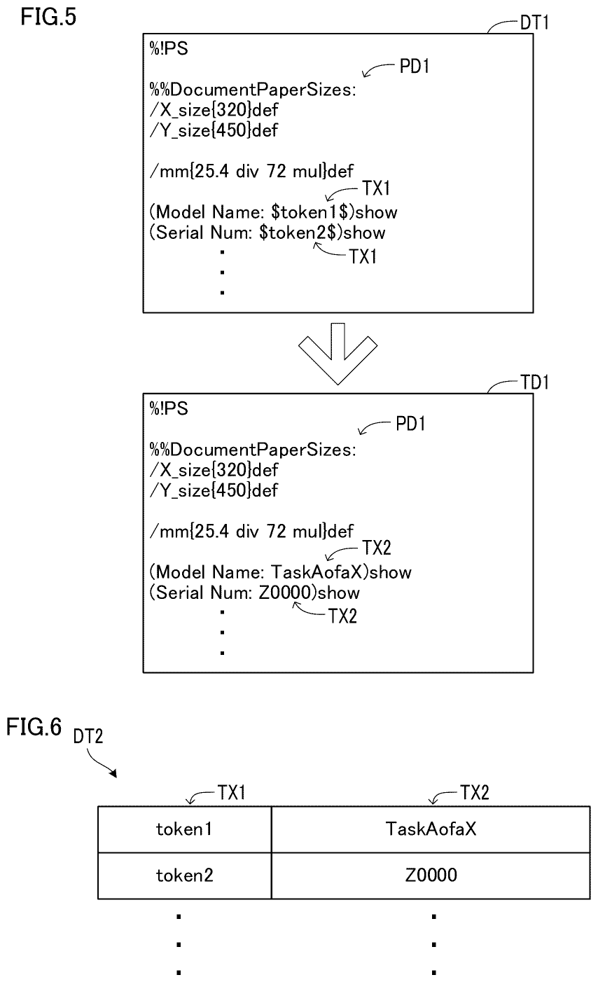

The registration data DT1 is data including page description data PD1 and one or more tokens TX1 (see FIG. 5).

The page description data PD1 is data expressing, by a page description language, the test image and information on a print condition. For example, the page description data PD1 is data expressing the test image and the information on the print condition by PostScript.

For example, the print condition includes a sheet type condition, an output surface condition, and the like. The sheet type condition indicates a type of the sheet 9 on which the test image is to be formed. The output surface condition indicates which of one surface and both surfaces of the sheet 9 the test image is to be formed on.

The token TX1 is a character string common to a plurality of models of the image forming apparatuses 10. The token TX1 is a character string that substitutes unique information of the image forming apparatus 10. For example, the unique information includes a model name of the image forming apparatus 10, a serial number of the image forming apparatus 10, or the like.

As shown in FIG. 6, the token conversion data DT2 indicates a correspondence relationship between the one or more tokens TX1 and one or more pieces of apparatus-specific data TX2 expressing the unique information of the image forming apparatus 10. The token TX1 functions as a search key used for specifying the apparatus-specific data TX2 in the token conversion data DT2.

After executing the processing of Step S101, the main control portion 8a shifts the processing to Step S102.

### <Step S102>

In Step S102, the main control portion 8a generates test PDL data TD1 based on the registration data DT1 obtained in Step S101 (see FIG. 5).

The main control portion 8a substitutes the token TX1 in the registration data DT1 with the apparatus-specific data TX2 corresponding to the token TX1 to thus generate the test PDL data TD1.

Accordingly, the test PDL data TD1 includes the page description data PD1 that expresses the test image and the information on the print condition by the page description language and the apparatus-specific data TX2 corresponding to the token TX1 (see FIG. 5).

In the present embodiment, the apparatus-specific data TX2 in the test PDL data TD1 expresses an apparatus information image configuring a part of the test image. In other words, in the test PDL data TD1, the page description data PD1 and the apparatus-specific data TX2 express the test image.

After executing the processing of Step S102, the main control portion 8a shifts the processing to Step S103.

### <Step S103>

In Step S103, the main control portion 8a transmits the test PDL data TD1 generated in Step S102 to the image processing apparatus 6 via the communication device 85. After executing the processing of Step S103, the main control portion 8a shifts the processing to Step S104.

### <Step S104>

In Step S104, the main control portion 8a receives job data JD1 from the image processing apparatus 6 via the communication device 85.

The job data JD1 is data received in accordance with the transmission of the test PDL data TD1. The job data JD1 includes raster data expressing the test image and the information on the print condition included in the test PDL data TD1.

After executing the processing of Step S104, the main control portion 8a shifts the processing to Step S105.

### <Step S105>

In Step S105, the print control portion 8b causes the printing device 5 to execute test print processing in correspondence with the reception of the job data JD1.

The test print processing is processing of forming the test image that is based on the raster data of the job data JD1 on the sheet 9 according to the print condition of the job data JD1.

By executing the processing of Step S105, the image forming apparatus 10 discharges the sheet 9 on which the test image has been formed.

The user of the image forming apparatus 10 performs an adjustment measure selected from a plurality of adjustment candidates according to a condition of the test image formed on the sheet 9.

For example, the plurality of adjustment candidates include performing, with respect to the operation device 801, an operation for causing the image forming apparatus 10 to execute various types of adjustment processing. For example, the adjustment processing includes head cleaning processing, print concentration correction processing, print position correction processing, and the like.

After executing the processing of Step S105, the print control portion 8b ends the processing of the image forming apparatus 10 in the test print control.

The processing of Step S101 to Step S103 is an example of processing for realizing an image forming control method. The CPU 81 that executes the processing of Step S101 to Step S103 is an example of a processor which realizes the image forming control method.

Meanwhile, in the image processing apparatus 6, the main processing portion 6a of the CPU 61 stands by until the test PDL data TD1 is transmitted from the image forming apparatus 10. The main processing portion 6a executes processing of Step S201 when the test PDL data TD1 is transmitted from the image forming apparatus 10.

### <Step S201>

In Step S201, the main processing portion 6a receives the test PDL data TD1 from the image forming apparatus 10 via the communication device 65.

After executing the processing of Step S201, the main processing portion 6a shifts the processing to Step S202.

### <Step S202>

In Step S202, the image processing portion 6b converts the test PDL data TD1 received in Step S201 into the job data JD1.

Specifically, the image processing portion 6b extracts the information on the print condition, the apparatus-specific data TX2, and the page description data PD1 in the test PDL data TD1. In addition, the image processing portion 6b converts the page description data PD1 and the apparatus-specific data TX2 in the test PDL data TD1 into raster data expressing the test image.

Further, the image processing portion 6b generates the job data JD1 including the extracted information on the print condition and the raster data. Thus, the test PDL data TD1 is converted into the job data JD1.

After executing the processing of Step S202, the image processing portion 6b shifts the processing to Step S203.

### <Step S203>

In Step S203, the main processing portion 6a transmits the job data JD1 to the image forming apparatus 10 via the communication device 65.

After executing the processing of Step S203, the main processing portion 6a ends the processing of the image processing apparatus 6 in the test print control.

The CPU 61 that executes the processing of Step S201 to Step S203 is an example of a data processing portion.

In the present embodiment, the main control portion 8a of the image forming apparatus 10 executes upgrade processing when a data update event occurs.

The upgrade processing includes processing of acquiring new registration data DT1 from the server 7 on a cloud via the communication device 85 and updating the registration data DT1 in the secondary storage device 83 to the new registration data DT1.

For example, the data update event is an event that an upgrade instruction has been input via the human interface device 800 or the communication device 85.

Specifically, the main control portion 8a of the image forming apparatus 10 or a host apparatus (not shown) executes upgrade inquiry processing upon receiving an upgrade notification from the server 7 via the communication device 85.

The host apparatus is an information processing apparatus used by an administrator of the image forming apparatus 10. The host apparatus is communicable with the image forming apparatus 10 via the network 60.

In the upgrade inquiry processing, the main control portion 8a inquires of the administrator whether or not the upgrade processing is necessary via the human interface device 800.

In the upgrade inquiry processing, detection of a permission operation by the operation device 801 means an input of the upgrade instruction.

Similarly, in the upgrade inquiry processing, the host apparatus inquires of the administrator whether or not the upgrade processing is necessary via a human interface device of the host apparatus.

In the upgrade inquiry processing, the host apparatus transmits the upgrade instruction to the image forming apparatus 10 when a permission operation is detected by the human interface device of the host apparatus.

As described heretofore, in the image forming apparatus 10, the main control portion 8a executes the processing of Step S101 to Step S103 when the test print event occurs.

In Step S101 to Step S102, the main control portion 8a acquires the registration data DT1 from the secondary storage device 83 and substitutes the token TX1 in the registration data DT1 with the apparatus-specific data TX2, to thus generate the test PDL data TD1.

In Step S103, the main control portion 8a transmits the test PDL data TD1 to the image processing apparatus 6 via the communication device 85.

In addition, the main control portion 8a executes the processing of Step S104 in correspondence with the transmission of the test PDL data TD1. In Step S104, the main control portion 8a receives the job data JD1 corresponding to the test PDL data TD1 from the image processing apparatus 6 via the communication device 85.

Further, the print control portion 8b executes the processing of Step S105 in correspondence with the reception of the job data JD1. In Step S105, the print control portion 8b causes the printing device 5 to execute the test print processing.

Meanwhile, the image processing apparatus 6 executes the processing of Step S201 to Step S203. In Step S201, the main processing portion 6a receives the test PDL data TD1 from the image forming apparatus 10.

In Step S202, the image processing portion 6b converts the test PDL data TD1 into the job data JD1. In Step S203, the main processing portion 6a transmits the job data JD1 to the image forming apparatus 10.

The data size of the registration data DT1 is very small as compared to the data size of the job data JD1 including the raster data. The registration data DT1 is an example of data related to the test image.

Accordingly, by adopting the image forming system 100, a load of the upgrade processing for updating the registration data DT1 is reduced.

In addition, the processing of generating the raster data expressing the test image every time the test print event occurs is executed by the image processing apparatus 6. Therefore, the processing load of the image forming apparatus 10 each time the test print event occurs is reduced.

Furthermore, the apparatus-specific data TX2 unique to each of the image forming apparatuses 10 is substituted with the token TX1 common to the plurality of models of the image forming apparatuses 10 in the registration data DT1. Thus, one piece of registration data DT1 can be shared by the plurality of models of the image forming apparatuses 10. As a result, the task and processing for upgrading the registration data DT1 are simplified.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming control method for controlling an image forming apparatus including a printing device which forms an image on a sheet and a communication device, comprising:
transmitting, by a processor, when a test print event occurs, test PDL data which is data expressing a test image and information on a print condition by a page description language, to an image processing apparatus via the communication device;
receiving, by the processor, job data including raster data expressing the test image and the information on the print condition from the image processing apparatus via the communication device in correspondence with the transmitting of the test PDL data; and
causing, by the processor, the printing device to execute processing of forming the test image that is based on the raster data on the sheet according to the print condition in correspondence with the receiving of the job data.

2. The image forming control method according to claim 1, wherein
the image forming apparatus includes a nonvolatile storage device which stores the data expressing the test image and the information on the print condition by the page description language, registration data including a token, and apparatus-specific data expressing unique information of the image forming apparatus, and
the image forming control method further comprises:
acquiring, by the processor, when a data update event occurs, new registration data from a server via the communication device and updating the registration data in the storage device to the new registration data; and
acquiring, by the processor, when the test print event occurs, the registration data from the storage device and substituting the token in the registration data with the apparatus-specific data, to thus generate the test PDL data.

3. An image forming apparatus, comprising:
a printing device which forms an image on a sheet;
a communication device; and
a processor which realizes the image forming control method according to claim 1.

4. An image forming system, comprising:
the image forming apparatus according to claim 3; and
an image processing apparatus communicable with the image forming apparatus, wherein
the image processing apparatus includes a data processing portion which receives the test PDL data from the image forming apparatus, converts the test PDL data into the job data, and transmits the job data to the image forming apparatus.
